(19) United States
(12) Patent Application Publication
(10) Pub. No.: US 2017/0269492 A1
(43) Pub. Date: Sep. 21, 2017

(54) ELECTROSTATIC CHARGE IMAGE DEVELOPING TONER, ELECTROSTATIC IMAGE CHARGE DEVELOPER, AND TONER CARTRIDGE

(71) Applicant: FUJI XEROX CO., LTD., Tokyo (JP)

(72) Inventors: Shinichi YAOI, Kanagawa (JP); Yasushige NAKAMURA, Kanagawa (JP); Seijiro ISHIMARU, Kanagawa (JP); Asafumi FUJITA, Kanagawa (JP)

(73) Assignee: FUJI XEROX CO., LTD., Tokyo (JP)

(21) Appl. No.: 15/220,022

(22) Filed: Jul. 26, 2016

(30) Foreign Application Priority Data
Mar. 18, 2016 (JP) 2016-055120

(51) Int. Cl. G03G 9/00

(52) U.S. Cl. CPC G03G 9/08755; G03G 15/0822; G03G 9/0819; G03G 9/08786; G03G 9/0904

(57) ABSTRACT

An electrostatic charge image developing toner includes toner mother particles that contain a polyester resin which is a polycondensate of a polycarboxylic acid compound and a polyol compound; a graft polymer which includes a polyolefin chain and a vinyl resin chain; a coloring agent; and polyethylene wax, provided that the polyol compound includes a polyol compound having a bisphenol structure in an amount of 0 mol % to 5 mol %, wherein a normal temperature and normal humidity aggregation degree of the toner mother particles is from 70% to 97%.

### CROSS-REFERENCE TO RELATED APPLICATIONS

This application is based on and claims priority under 35 USC 119 from Japanese Patent Application No. 2016-055120 filed Mar. 18, 2016.

### BACKGROUND

1. Technical Field

The present invention relates to an electrostatic charge image developing toner, an electrostatic charge image developer, and a toner cartridge.

2. Related Art

Methods for visualizing image information via electrostatic images, such as an electrostatic photography method, are currently used in various fields. In the electrostatic photography method, an electrostatic image (an electrostatic charge image) is formed on a photoreceptor (an image holding member) by a step of charging and exposing and the electrostatic charge image is visualized through steps of developing using a developer which includes a toner, transferring, and fixing. In the developers used herein, there are two-component developers formed of a toner and a carrier and single-component developers which use a magnetic toner or non-magnetic toner alone; however, as the method for preparing the toner, a kneading and pulverizing method is normally used in which, after a thermoplastic resin is molten-kneaded together with a pigment, a charge-controlling agent, and a release agent such as wax and cooled, the resultant is mill-pulverized and further classified. In these toners, inorganic or organic particles may be added to the toner particle surface in order to improve the fluidity and cleaning properties as necessary.

### SUMMARY

According to an aspect of the invention, there is provided an electrostatic charge image developing toner including:

toner mother particles that contain a polyester resin which is s polycondensate of a polycarboxylic acid compound and a polyol compound;

a graft polymer which includes a polyolefin chain and a vinyl resin chain;

a coloring agent; and

polyethylene wax,

provided that the polyol compound includes a polyol compound having a bisphenol structure in an amount of 0 mol % to 5 mol %,

wherein a normal temperature and normal humidity aggregation degree of the toner mother particles is from 70% to 97%.

### BRIEF DESCRIPTION OF THE DRAWINGS

Exemplary embodiments: of the present invention will be described in detail based on the following figures, wherein:

FIG. 1 is a schematic configuration diagram which shows an example of an image forming apparatus preferably used in the exemplary embodiment.

### DETAILED DESCRIPTION

Description will be given below of the exemplary embodiment.

In the following description, unless otherwise stated, description where a numerical range is represented by “A to B” is synonymous with “A or more to B or less” and has the meaning of a numerical range which includes A and B as end points.

In addition, in the following description, “(meth)acryl” is an expression which includes both “acryl” and “methacryl”. The same applies to the expressions such as “(meth)acrylonitrile” and “(meth)acryloxy group”.

(1) Electrostatic Charge Image Developing Toner

An electrostatic charge image developing toner (also simply referred to as “toner”) according to the exemplary embodiment includes a polyester resin which is a polycondensate of a polycarboxylic acid compound and a polyol compound, a graft polymer which includes a polyolefin chain and a vinyl resin chain, and toner mother particles which contain a coloring agent and polyethylene wax, in which, in the polyol compound, content of a polyol compound which has a bisphenol structure is 0 mol % to 5 mol %, and normal temperature and normal aggregation degree of the toner mother particles is 70% to 97%.

(Toner Mother Particles)

The toner mother particles in the exemplary embodiment contain a polyester resin which is a polycondensate of a polycarboxylic acid compound and a polyol compound, a graft polymer which includes a polyolefin chain and a vinyl resin chain, a coloring agent, and polyethylene wax.

<Polyester Resin which is Polycondensate of Polycarboxylic Acid Compound and Polyol Compound>

The electrostatic charge image developing toner according to the exemplary embodiment includes a polyester resin which is a polycondensate of a polycarboxylic acid compound and a polyol compound.

The electrostatic charge image developing toner according to the exemplary embodiment preferably contains the polyester resin as a binding resin.

The polyester resin is preferably a polyester resin which is a polycondensate of a diol compound, a dicarboxylic acid compound, and a tricarboxylic acid compound, and more preferably a polyester resin which is a polycondensate of an aliphatic diol compound, a dicarboxylic acid compound, and a tricarboxylic acid compound.

[Polyol Compound]

In the polyol compound in the polyester resin, 70 mol % to 100 mol % is preferably an aliphatic polyol compound, 80 mol % to 100 mol % is more preferably an aliphatic polyol compound, 90 mol % to 100 mol % is even more preferably an aliphatic polyol compound, and 100 mol % is particularly preferably an aliphatic polyol compound. With the aspect described above, the fixing property is superior.

In addition, in the polyol compound in the polyester resin, 20 mol % to 70 mol % is preferably ethylene glycol and/or neopentyl glycol, and 30 mol % to 60 mol % is more preferably ethylene glycol and/or neopentyl glycol. With the aspect described above, the fastness is superior.

From the point of view of durability, examples of the aliphatic polyol compound are preferably an aliphatic polyol compound which has 2 to 8 carbon atoms, and more preferably an aliphatic polyol compound which has 2 to 6 carbon atoms.

Examples of aliphatic polyol compounds include diol compounds such as ethylene glycol, 1,2-propylene glycol, 1,3-propylene glycol, 1,4-butanediol, 1,5-pentanediol, 1,6-hexane diol, neopentyl glycol, 1,4-butene diol, 1,7-heptane diol, and 1,8-octanediol, and trivalent or higher polyol compounds such as glycerin, pentaerythritol, and trimethylolpropane. Among these, ethylene glycol and/or neopentyl glycol are more preferable.

According to the aspect described above, it is possible to prevent machine contamination of a printer in a high-temperature and high-humidity environment and obtained images have an excellent fixing property.

—Bisphenol Structure—

In the polyol compound, the content of the polyol compound which has a bisphenol structure is 0 mol % to 5 mol %, preferably 0 mol % to 3 mol %, more preferably 0 mol % to 2 mol %, even more preferably 0 mol % to 1 mol %, and particularly preferably 0 mol %, that is, a polyol compound which has a bisphenol structure is not contained.

Examples of bispnenol structures include structures such as Bisphenol A, Bisphenol AP, Bisphenol AF, Bisphenol B, Bisphenol BP, Bisphenol C, Bisphenol S, Bisphenol F, Bisphenol G, Bisphenol M, Bisphenol S, Bisphenol P, Bisphenol PH, Bisphenol TMC, and Bisphenol Z.

Examples of polyol compounds which have a bisphenol structure include divalent aromatic alcohols such as an alkylene (2 to 3 carbon atoms) oxide (average addition molar number of 1 to 10) adduct of bisphenol A or the like.

In addition, the polyester resin preferably has a monomer unit represented by the following formula (3) as a monomer unit derived from the aliphatic polyol compound.

O-R^{al}-O (3)

In formula (3), R^{al} represents an alkylene group having 2 to 8 carbon atoms.

The alkylene group in R^{al} may be a straight-chain alkylene group, or may be a branched alkylene group.

In formula (3), R^{al} is preferably an alkylene group having 2 to 4 carbon atoms, and more preferably an alkylene group having 2 or 3 carbon atoms.

Furthermore, the polyester resin preferably includes 15 weight % to 70 weight % of the monomer unit which is represented by formula (3), more preferably includes 20 weight % to 65 weight %, and even more preferably includes 30 weight % to 60 weight % with respect to the total, weight of the polyester resin.

[Polycarboxylic Acid Compound]

Specific examples of divalent carboxylic acid compounds in the polyvalent carboxylic acid compounds include aliphatic dicarboxylic acid compounds such as maleic acid, fumaric acid, succinic acid, adipic acid, malonic acid, sebacic acid, and mesaconic acid, or anhydrides and lower alkyl esters thereof; aromatic dicarboxylic acid compounds such as phthalic acid, isophthalic acid, terephthalic acid, toluene dicarboxylic acid, and naphthalene dicarboxylic acid, or anhydrides and lower alkyl esters thereof; and alkyl or alkenyl (anhydrous) succinic acids saving a hydrocarbon group having 4 to 35 carbon atoms in a side chain, specifically, dodecenyl (anhydrous) succinic acid, pentadodecenyl (anhydrous) succinic acid, and the like, or anhydrides and lower alkyl esters thereof, and the like.

Specific examples of trivalent or higher carboxylic acid compounds: include trimellitic acid, pyromellitic acid, 1,2,4-cyclohexane tricarboxylic acid, 2,5,7-naphthalene tricarboxylic acid, 1,2,4-naphthalene tricarboxylic acid, 1,2,5-hexane tricarboxylic acid, and 1,2,7,8-octane tetracarboxylic acid, or anhydrides and lower alkyl esters thereof. These may be used as one type alone, or may be used in a combination of two types or more.

Among these, divalent carboxylic acid compounds and trivalent carboxylic acid compounds are preferable, and terephthalic acid and trimellitic acid are more preferable. As the use ratio of the divalent carboxylic acid compound and the trivalent carboxylic acid compound, a molar ratio where the divalent carboxylic acid compound:trivalent carboxylic acid compound is 2:1 to 50:1 is preferable, and 3:1 to 10:1 is more preferable.

From the point of view of the charging property, the polyvalent carboxylic acid compounds preferably include an aromatic polycarboxylic acid compound.

The content of the aromatic polycarboxylic acid compound is preferably 30 mol % to 100 mol %, and even more preferably 50 mol % to 100 mol %, with respect to the total molar number of the polyvalent carboxylic acid compound.

In addition, in the polyester resin, the total molar number of the hydroxy groups of the polyol compound is preferably greater than the total molar number of the carboxyl groups of the polycarboxylic acid compound.

The polyester resin is preferably a polyester resin formed by polycondensation of an epoxy compound in addition to a polycarboxylic acid compound and a polyol compound.

The epoxy compound is preferably a polyvalent epoxy compound.

Examples o epoxy compounds include bisphenol A type epoxy resins, novolak type epoxy resins, polymers or copolymers of a vinyl compound which has an ethylene glycol diglycidyl ether, a glycerin triglycidyl ether, a trimethylolpropane triglycidyl ether, a trimethylolethane triglycidyl ether, a pentaerythritol tetraglycidyl ether, a hydroquinone diglycidyl ether, cresol novolak type epoxy resins, phenol novolak type epoxy resins, or an epoxy group, an epoxidized resorcinol-acetone condensate, partially epoxidized polybutadiene, and the like. Among these, from the point of view of reactivity, preferable examples include cresol novolak type epoxy resins, and phenol novolak type epoxy resins.

In the polyester resin, the use amount of the epoxy compound is preferably 1 mol % to 20 mol %, more preferably 2 mol % to 15 mol %, and particularly preferably 5 mol % to 12 mol % with respect to the total amount of the polyol compound.

[Properties of Polyester Resin]

As the polyol compound and/or polycarboxylic acid compound component, from the point of view of the fastness, it is preferable to include a trivalent or higher polyol compound and/or a trivalent or higher polycarboxylic acid compound.

The content of the trivalent or higher polyol compound and/or trivalent or higher polycarboxylic acid compound is preferably 0.1 mol % to 20 mol %, and more preferably 1 mol % to 15 mol % with respect to the total molar amount of the alcohol compound and carboxylic acid compound.

In addition, the acid value of the polyester resin is preferably 5 mgKOH/g to 70 mgKOH/g.

It is possible to measure the acid value of the polyester resin by dissolving the resin in tetrahydrofuran (THF) and carrying out titration using an automatic potentiometric titrator in accordance with the JIS K2501-2003 method.

The weight average molecular weight Mw of the polyester resin is preferably 5,000 to 200,000, and more preferably 10,000 to 100,000.

The weight average molecular weights of the resins in the exemplary embodiment are all obtained by molecular weight measurement using a gel permeation chromatography (GPC) method with the tetrahydrofuran (THF) soluble component. The THF soluble component was measured in a THF solvent using TSK-GEL (GMH (manufactured by Tosoh Corporation)) or the like and the molecular weight of the resin was calculated using a molecular weight calibration curve obtained from standard monodisperse polystyrene samples.

[Polyester Resin Content]

The polyester resin may be contained alone as one type or may be contained as two or more types.

The content of the polyester resin in the electrostatic charge image developing toner according to the exemplary embodiment is preferably 50 weight % to 99 weight %, more preferably 60 weight % to 97 weight %, and particularly preferably 70 weight % to 95 weight % with respect to the total weight of the toner.

<Graft Polymer including Polyolefin Chain and Vinyl Resin Chain>

The electrostatic charge image developing toner of the present in vent ion includes, a graft polymer which includes a polyolefin chain and a vinyl resin chain.

[Polyolefin Chain]

The polyolefin chain is not particularly limited as long as the polyolefin chain is a molecular chain derived from a known polyolefin; however, the polyolefin chain is preferably a molecular chain derived from polyethylene and/or polypropylene.

The polyolefin chain is preferably a polyolefin which has a binding site with the vinyl resin chain.

In addition, as the polyolefin described above, it is possible to preferably use waxes such as paraffin wax, paraffin latex, and microcrystalline wax, and more preferably polypropylene wax, or polyethylene wax.

The weight average molecular weight of the polyolefin described above is preferably 400 to 50,000, more preferably 400 to 30,000, and even more preferably 400 to 15,000.

The content of the polyolefin chain is preferably 8 weight % to 35 weight %, and more preferably 10 weight % to 30 weight % with respect to the total weight of the graft polymer including a polyolefin chain and a vinyl resin chain.

[Vinyl Resin Chain]

The vinyl resin chain is not particularly limited as long as the vinyl resin chain is a vinyl resin which has a binding site with the polyolefin chain described above.

The content of the vinyl resin chain is preferably 50 weight % to 95 weight %, and more preferably 60 weight % to 80 weight % with respect to the total weight of the graft polymer including a polyolefin chain and a vinyl resin chain.

The glass transition point (Tg) of the vinyl resin is preferably 40° C. to 80° C. Tg refers to the value measured by the method (DSC method) prescribed in ASTM D3418-82.

The vinyl resins described above are not particularly limited and examples thereof include (meth)acrylic resin, styrene (meth)acrylic resin, polystyrene, polyacrylonitrile, styrene (meth)acrylonitrile copolymer, styrene (meth)acrylonitrile (meth)acrylic acid ester copolymer, and the like, and a styrene-(meth)acrylonitrile (meth)acrylic acid ester copolymer is preferable.

In addition, the vinyl resin preferably includes a structure from a styrene compound, a structure derived from a (meth)acrylonitrile compound, and/or a structure derived from acrylic acid or an ester compound thereof, and more preferably includes a structure derived from a styrene compound, a structure derived from a (meth)acrylonitrile compound, and a structure derived from (meth)acrylic acid or an ester compound thereof.

In the exemplary embodiment, in a case where the vinyl resin includes a structure derived from a styrene compound, a structure derived from a (meth)acrylonitrile compound, and a structure derived from (meth)acrylic acid or an ester compound thereof, the total content thereof is preferably 50 weight % or more, more preferably 60 weight % or more, and more preferably 80 weight % or more with respect to the total weight of the vinyl resin. The upper limit is not particularly limited, but may be 100 weight % or less.

—Styrene Compound—

Examples of styrene compounds include styrene, 4-methylstyrene, 4-hydroxystyrene, 4-acetoxystyrene, 4-acetylstyrene, styrene sulfonic acid, and the like. Among these, styrene is preferable.

In the exemplary embodiment, in a case where the vinyl resin includes a structure derived from a styrene compound, the content thereof is preferably 20 weight % to 90 weight %, and more preferably 30 weight % to 80 weight % with respect to the total weight of the vinyl resin.

—(Meth)Acrylonitrile Compound—

Examples of (meth)acrylonitrile compounds include (meth)acrylonitrile, and acrylonitrile is preferable.

In the exemplary embodiment, in a case where the vinyl resin includes a structure derived from a (meth) acrylonitrile compound, the content thereof is preferably 1 weight % to 40 weight % and more preferably 5 weight % to 30 weight % with respect to the total weight of the vinyl resin.

—(Meth)Acrylic Acid or Ester Compounds Thereof—

Examples of (meth)acrylic acid or ester compounds thereof include (meth)acrylic acid or alkyl ester compounds thereof. Examples of alkyl groups in the alkyl ester compound of the (meth)acrylic acid include alkyl groups having 1 to 8 carbon atoms, preferably alkyl groups having 1 to 4 carbon atoms. The alkyl groups described above may be straight chain or branched chain, or may have a cyclic structure.

In the exemplary embodiment, in a case where the vinyl resin includes a structure derived from (meth)acrylic acid or an ester compound thereof, the content thereof is preferably 1 weight % to 40 weight %, and more preferably 5 weight % to 30 weight % with respect to the total weight of the vinyl resin.

[Method for Preparing Graft Polymer including Polyolefin Chain and Vinyl Resin Chain]

In the exemplary embodiment, the graft polymer including a polyolefin chain and a vinyl resin chain may be prepared by mixing polyolefin with a radical polymerizable monomer which is a raw material for a vinyl resin chain in the presence of an organic peroxide which is a radical polymerization initiator, and then heating the result.

Examples of radical polymerizable monomers include the styrene compound, (meth)acrylonitrile compound, (meth)acrylic acid, or ester compounds thereof described above.

The organic peroxides to be used are not particularly limited and it is possible to use known organic peroxides used as radical polymerization initiators; however, it is possible to preferably use t-butyl peroxide, benzoyl peroxide, t-butyl peroxy benzoate, and the like.

[Characteristics of Graft Polymer including Polyolefin Chain and Vinyl Resin Chain]

In the graft polymer including a polyolefin chain and a vinyl resin chain used in the exemplary embodiment, the content weight ratio of the polyolefin chain and the vinyl resin chain is preferably polyolefin chain: vinyl resin chain=5:95 to 50:50, and more preferably 10:90 to 30:70.

The weight average molecular weight of the graft polymer including a polyolefin chain and a vinyl resin chain is preferably 3,000 to 50,000.

[Content of Graft Polymer including Polyolefin Chain and Vinyl Resin Chain]

The above-described graft polymer including the polyolefin chain and the vinyl resin chain may be contained alone as one type or as two or more types. The above-described graft polymer including the polyolefin chain and the vinyl resin chain is preferably contained as 0.5 weight % to 10 weight %, more preferably 0.8 weight % to 8 weight %, and particularly preferably 1 weight % to 7 weight % with respect to the total weight of the toner.

<Coloring Agent>

The electrostatic charge image developing toner according to the exemplary embodiment contains a coloring agent.

The coloring agent may be a pigment or may be a dye; however, a pigment is used from the viewpoints of light resistance and water resistance. In addition, the coloring agent is not limited to colored coloring agents, but also includes white coloring agents and coloring agents having a metallic color.

As the coloring agent, for example, known pigments are used such as Carbon black, Aniline black, Aniline blue, Kalcol Blue, Chrome yellow, Ultramarine Blue, Du Pont Oil Red, Quinoline yellow, Methylene blue chloride, Phthalocyan Blue, Malachite green oxide, Lamp black, Rose Bengal, Quinacridone, Benzidine yellow, C. I. Pigment Red 48: 1, C. I. Pigment Red 57: 1, C. I. Pigment Red 122, C. I. Pigment Red 185, C. I. Pigment Red 238, C. I. Pigment Yellow 12, C. I. Pigment Yellow 17, C. I. Pigment Yellow 180, C. I. Pigment Yellow 97, C. I. Pigment Yellow 74, C. I. Pigment Blue 15:1, C. I. Pigment Blue 15:3, or the like.

The content of the coloring agent in the electrostatic charge image developing toner according to the exemplary embodiment is preferably 1 to 30 parts by weight with respect to 100 parts by weight of the binder resin.

In addition, it is also effective to use a surface-treated coloring agent or to use a pigment dispersing agent. A yellow toner, magenta toner, cyan toner, black toner, or the like is prepared by selecting the type of the coloring agent.

<Polyethylene Wax>

The electrostatic charge image developing toner according to the exemplary embodiment contains polyethylene wax.

The weight average molecular weight of the polyethylene wax is preferably 2,000 or more, and more preferably 3,000 or more. The upper limit of the weight average molecular weight is not particularly limited; however, 20,000 or less is preferable.

[Polyethylene Wax Content]

The content of the polyethylene wax is preferably 0.5 weight % to 8 weight %, and more preferably 1 weight % to 6 weight % with respect to the total weight of the toner.

<Other Binder Resin>

The electrostatic charge image developing toner according to the exemplary embodiment may contain a resin component other than the above-described polyester resin and the graft polymer including the polyolefin chain and the vinyl resin chain as another binder resin; however, such a resin component is preferably not included.

In a case where a binding resin other than, the polyester resin is included, the content thereof is less than the content of the polyester resin, preferably 10 weight % or less, and more preferably 5 weight % with respect to the total weight of the toner, and the binding resin other than the polyester resin is particularly preferably not included.

The other binder resin is not particularly limited; however, examples thereof include styrenes such as styrene, para-chloro styrene, and α-methyl styrene; esters having a vinyl group such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate; vinyl nitrites such as acrylonitrile, and methacrylonitrile; vinyl ethers such as vinyl methyl ether, and vinyl isobutyl ether; vinyl ketones such as vinyl methyl ketone, vinyl ethyl ketone, and vinyl isopropenyl ketone; homopolymers formed of monomers such as polyolefins such as ethylene, propylene, and butadiene, or copolymers obtained by combining two or more types thereof, as well as mixtures thereof. In addition, examples include epoxy resin, polyester resin other than the polyester resin described above, polyorethane resin, polyamide resin, cellulose resin, polyether resin, and the like, non-vinyl condensation resin, or, and mixtures of the above and vinyl resin, graft polymers obtained by polymerizing a vinyl monomer in the presence of the above, and the like.

Styrene resin, (meth)acrylic resin, and styrene-(meth)acrylic copolymer resin are, for example, obtained by a known method which uses a styrene monomer and a (meth)acrylic acid monomer alone or in combination as appropriate.

In a case where the styrene resin, the (meth)acrylic resin, and the copolymer resins thereof are used as a hinder resin, the above are preferably used with the weight average molecular weight Mw being in a range of 20,000 or more to 100,000 or less, and the number average molecular weight Mn being in a range of 2,000 or more to 30,000 or less.

<Other Wax>

In the toner or the exemplary embodiment, examples of waxes other than the polyethylene wax described above include: ester wax, polypropylene or a copolymer of polyethylene and polypropylene, polyglycerol wax, microcrystalline wax, paraffin wax, carnauba wax, sasol wax, montanic acid ester wax, deoxidation carnauba wax, palmitic acid, stearic acid, montanic acid, plandinic acid, eleostearic acid, unsaturated, fatty acids such as parinaric acid, stearin alcohol, aralkyl alcohol, behenyl alcohol, carnaubyl alcohol, seryl alcohol, melissyl alcohol, or saturated alcohols such as long-chain alkyl alcohols having a long-chain alkyl group; polyols such as sorbitol; fatty amides such as linoleic acid amide, oleic acid amide, and lauric acid amide; saturated fatty bisamides such as methylene bis stearic acid amide, ethylene capric acid amide, ethylene bis lauric acid amide, and hexamethylene-bis-stearic acid amide; unsaturated fatty acid amides such as ethylene-bis-oleic acid amide, hexamethylenebis oleic acid amide, N,N′-dioleyl adipic acid amide, and N,N′-dioleylsebacic acid amide; aromatic bisamides such as m-xylene bis stearic acid amide, and N,N′-distearyl isophthalic acid amide; fatty acid metal salts such as calcium stearate, calcium lauric acid, zinc stearate, and magnesium stearate (typically known as metallic soaps); waxes obtained by grafting using vinyl monomers such as styrene or acrylic acid with an aliphatic hydrocarbon wax; partial esterification products of fatty acids such as behenic acid monoglyceride and polyols; methyl ester compounds having a hydroxyl group obtained by hydrogenating vegetable oils; and the like.

As the other wax described above, a wax material exhibiting an endothermic peak at 50° C. to 160° C. according to differential scanning calorimetry (DSC) measurement is preferable. In the DSC measurement, the measurement is preferably carried out using a high-precision inner heat input compensation type differential scanning calorimeter from the measuring principles.

The total content of the other wax described above and the polyethylene wax described above is preferably 0.5 weight % to 15 weight %, and more preferably 1 weight % to 10 weight % with respect to the total weight of the toner.

<Other Additives>

In addition to the components described above, various components such as internal additives, charge-controlling agents, and infrared absorbing agents may be added as necessary, to the electrostatic charge image developing toner according to the exemplary embodiment.

Examples of internal additives include metals such as ferrite, magnetite, reduced iron, cobalt, nickel, and manganese, alloys, or magnetic materials such as compounds including these metals.

Examples of charge controlling agents include quaternary ammonium salt compounds, nigrosine compounds, dyes formed of complexes such as aluminum, iron, and chromium, triphenylmethane pigments, and the like.

In a case where the toner in the exemplary embodiment is used in an image forming apparatus using an optical fixing system, an infrared absorbing agent may be contained. As the infrared absorbing agent, it is possible to use known infrared absorbing agents, and examples thereof include cyanine compounds, merocyanine compounds, benzene thiol metal complexes, mercaptophenol metal complexes, aromatic diamine metal complexes, diimonium compounds, aminium compounds, nickel complex compounds, phthalocyanine compounds, anthraquinone compounds, naphthalocyanine compounds, and the like.

<Method of Preparing Toner Mother Particles>

The method for preparing toner mother particles is not particularly limited, and examples thereof mainly include suspension polymerization methods, dissolution suspension methods, emulsion polymerization methods, kneading and pulverizing methods, and the like.

In the kneading and pulverizing method, it is easy to widen the particle size distribution, and it is easy to increase the amount of fine powder while the volume average particle diameter is large.

In the emulsion polymerization method, it is easy to reduce the toner particle diameter while maintaining a narrow particle size distribution and the method has the advantage of being able to smooth or control the sphericity of the toner surface at the same time.

In a case of using the kneading and pulverizing method, for example, the toner particles are prepared in the following manner. For example, after sufficiently mixing a binder resin, a release agent, a charge-controlling agent, a coloring agents, and the like in a mixer such as HENSCHEL MIXER or a ball mill, molten-kneading is carried out using a heating and kneading machine such as a heating roll, a kneader, or an extruder, the release agent, the charge-controlling agent, the coloring agent are dispersed or dissolved, cooled, and solidified while carrying out compatibilization with the binder resin, after which the particle size distribution is adjusted by finely pulverizing the particles to a preferable particle size mechanically and then carrying out classification. Alternatively, after cooling and solidification, toner particles are obtained by being making the finely pulverized product, which is obtained by collision with a target under a jet stream, spherical by thermal or mechanical impact force.

In the pulverizing method, an IDS-2 TYPE COLLISION PLATE TYPE PULVERIZER (manufactured by Nippon Pneumatic Mfg. Co., Ltd.) is suitable for use in the pulverizing and an ELBOW JET CLASSIFIER (manufactured by MATSUBO Corporation) is suitable for use in one classification. In the pulverizing step, it is determined whether the particle diameter of the toner mother particles is decreased to become small and fine when the pulverizing pressure is increased or the processing rate is decreased, and the adjustment of the particle diameter of the toner mother particles is easily performed. Next, in the classification step, the adjustment of the amount of fine powder is easily performed by changing the classification edge position.

<Characteristics of Toner Mother Particles>

[Toner Mother Particle acquisition Method]

Examples of methods for making the toner mother particles by separating external additives or the like from the toner of the exemplary embodiment include the following methods.

The toner to which external additives were added is dispersed so as to be 10 weight % in an aqueous solution or 0.2 weight % of polyoxyethylene (10) octyl phenyl ether and the external additives are liberated by applying ultrasonic vibration (frequency 20 kHz, output 30 W) for 60 minutes while maintaining a temperature of 30° C. or less. It may obtain toner mother particles with the external additives removed by filtering the toner mother particles from the dispersion and cleaning the resultant.

Below, the normal temperature and normal humidity aggregation degree and the surface exposure ratio of polyethylene wax may be measured using toner mother particles obtained by the method described above.

[Normal Temperature and Normal Humidity Aggregation Degree]

The normal temperature and normal humidity aggregation degree of the toner mother particles according to the exemplary embodiment is 70% to 97%, preferably 75% to 95%, and more preferably 80% to 90%.

The normal temperature and normal humidity aggregation degree is the aggregation degree of the toner particles stored for 20 hours at 25° C. with a humidity of 50% RH.

Using a POWDER TESTER (manufactured by Hosokawa Micron Co., Ltd.), sieves with meshes of 56 μm, 45 μm, and 37 μm are set to be overlapped in order from the narrowest mesh on a vibration table, samples of 2 g are placed on the set sieves, the input voltage to the vibration table is set to 15 V, the vibration table amplitude is adjusted to be in the range of 70 μm to 90 μm, and vibration is applied for 90 seconds. After that, the weight of each sample remaining on each of the sieves is measured and calculated using the following formulas.

Aggregation degree (%)=(W₅₆/2)×100+(W₄₅/2)×100×0.6+(W₃₆/2)×100×0.2

(in the formula, W₅₆ represents the sample weight (g) remaining on the sieve with a mesh of 56 μm, W₄₅ represents the sample weight (g) remaining on the sieve with a mesh of 45 μm, and W₃₆ represents the sample weight (g) remaining on the sieve with a mesh of 38 μm)

[Surface Exposure Ratio of Polyethylene Wax]

The toner mother particle surface exposure ratio used in the exemplary embodiment is preferably 10 atomic % to 35 atomic %, more preferably 12 atomic % to 30 atomic %, and even more preferably 15 atomic % to 25 atomic %.

The surface exposure ratio of polyethylene wax of the toner mother particles is determined by measuring the toner mother particles obtained as described above under the conditions of an X-ray source MgK α and an output of 10 kV using an X-RAY PHOTOELECTRON SPECTROMETER (JPS-9000MX) manufactured by JASCO Corp., and calculating the surface atomic concentration from the peak intensity of each of the measured elements. The surface exposure ratio is calculated by the ratio of the atomic concentration derived from the polyethylene wax within the total sum of the atomic concentration of all of the elements.

<External Additives>

The electrostatic charge image developing toner according to the exemplary embodiment preferably includes an external additive.

The material of the external additive is not particularly limited and known inorganic particles and organic particles may be used as the external additive of the toner, for example, inorganic particles such as silica, alumina, titanium oxide (titanium oxide, metatitanic acid, or the like), cerium oxide, zirconia, calcium, carbonate, magnesium, carbonate, calcium phosphate, and carbon black, and resin particles such as vinyl resins, polyester resin, and silicone resin. Among these, the external additive is particularly preferably silica particles.

Examples of silica particles include silica particles such as fumed silica, colloidal silica, and silica gel, and the silica particles are used without particular limitation.

In addition, the external additive may be subjected to, for example, a hydrophobic treatment with a silane coupling agent to be described below or the like.

The hydrophobic treatment may be performed by dipping the particles in the hydrophobic treatment agent, or the like. The hydrophobic treatment agent is not particularly limited; however, examples thereof include a silane coupling agent, a titanate coupling agent, an aluminum coupling agent, and the like. The above may be used alone, or may be used in combination of two or more types. Among the above, a silane coupling agent is preferably used.

As the silane coupling agent, it is also possible to use chlorosilane, alkoxysilane, silazane, or any type of special silylating agents.

Specifically, examples include methyl trichlorosilane, dimethyldiohlorosilane, trimethylchlorosilane, phenyl trichlorosilane, diphenyldichlorosilane, tetramethoxysilane, methyl trimethoxysilane, dimethyldimethoxysilane, phenyl trimethoxysilane, diphenyidimethoxysilane, tetraethoxysilane, methyl triethoxysilane, dimethyl diethoxy silane, phenyltriethoxysilane, diphenyldiethoxysilane, isobutyl triethoxysilane, decyltrimethexysilane, hexamethyldisilazane, N,O-(bis trimethylsilyl) acetamide, N,N-(trimethylsilyl) urea, tert-batyldimethylchlorosilane, vinyl trichlorosilane, vinyl trimethoxysilane, vinyl triethoxysilane, γ-methacryloxypropyl trimethoxysilane, β-(3,4-epoxycyclohexyl) ethyl methoxysilane, γ-glycidoxypropyltrimethoxysilane, γ-glycidoxypropylmethyldiethoxysilane, β-mercaptopropyltrimethoxysilane, γ-chloropropyl trimethoxysilane, and the like.

The amount of the hydrophobic treatment agent depends on the type of the particles or the like and cannot be unconditionally defined; however, the amount is preferably 1 part by weight to 50 parts by weight and more preferably 5 parts by weight to 20 parts by weight with respect to 100 parts by weight of the particles. In the exemplary embodiment, commercial products are also suitable for use as the hydrophobic silica particles subjected to a hydrophobic treatment.

The primary average particle diameter of the external additive is preferably 1 nm to 500 nm, more preferably 5 nm to 300 nm, even more preferably 10 nm to 200 nm, and particularly preferably 10 nm to 50 nm.

The addition amount of the external additive is preferably in the range of 0.1 parts by weight to 5 parts by weight, and more preferably 0.3 parts by weight to 2 parts by weight with respect to 100 parts by weight of the toner. When the addition amount is 0.1 parts by weight or more, the fluidity of the toner is appropriate, the charging properties are superior, and the charge-exchange property is excellent. On the other hand, when the addition amount is 5 parts by weight or less, the coating state is appropriate, it is possible to prevent the external additive from being transferred to the contact member, and the formation of secondary defects is prevented.

<Toner Characteristics>

The volume average particle diameter of the electrostatic charge image developing toner according to the exemplary embodiment is preferably 5.0 μm to 14.0 μm, and more preferably 6.0 μm to 12.0 μm. When in the ranges described above, the effects of the exemplary embodiment are further exhibited.

For the measurement of the volume average particle diameter of the toner, a COULTER MULTISIZER-II MODEL (manufactured by Beckman Coulter, Inc.) is preferably used and ISOTON-II (manufactured by Beckman Coulter, Inc.) is preferably used for the electrolytic solution.

Specific examples of measurement methods include the following methods.

As a dispersing agent, 1.0 mg of the measurement sample is added into a surfactant, preferably 2 ml of a 5% aqueous solution of sodium alkylbenzenesulfonate. An electrolyte solution in which a sample is suspended is prepared by adding the resultant into 100 ml of an electrolyte. The electrolyte solution in which the sample is suspended is subjected to a 1 minute dispersion treatment in an ultrasonic disperser, and the volume average distribution and the number average distribution are determined by measuring the particle size distribution of 1 μm to 30 μm particles with the COULTER MULTISIZER-II MODEL using an aperture diameter of 50 μm as the aperture diameter. The number of particles to be measured is 50,000.

In addition, the particle size distribution of the electrostatic charge image developing toner according to the exemplary embodiment is preferably narrow, more specifically, a particle size distribution (GSDv) showing a ratio of the 16% diameter (D₁₆ᵥ) and the 84% diameter (D_{84V}) as a square root by conversion from the smallest volume particle diameter of the toner is preferable, that is, GSDv represented by the following formula is preferably 1.21 or less, more preferably 1.19 or less, and particularly preferably 1.17 or less.

GSDv={(D₆₄ᵥ)/(D₁₆ᵥ)}^{0.5} (1)

(In formula (1), D₆₄v and D₁₆v are particle diameters which are cumulatively 84% and 16% when depicting the volume cumulative distribution curve from the small particle diameter side with respect to each divided particle size range)

when GSDv is in the range described above, since the formation of particles where the toner charge amount is excessively large is prevented, the deterioration of the multi-color fine line reproducibility is further prevented.

Furthermore, in the electrostatic charge image developing toner according to the exemplary embodiment, a shape coefficient SF1 is preferably in a range of 110 or more to 140 or less, and more preferably in a range of 110 or more to 130 or less. By the shape being spherical in this range, the transfer efficiency and the density of the image are improved and a high-quality image is formed.

The shape factor SF1 described above is determined by the following formula (E).

SF1=(ML²/A)×(π/4)×100 Formula (E)

In the above formula (E), ML represents the absolute maximum length of the toner and A represents the projected area.

The SF1 is quantified mainly by analyzing a microscopic image or a scanning electron microscope (SEM) image using an image analyzer, for example, calculation is possible in the following manner. That is, an optical microscopic image of particles sprayed on the surface of a slide glass is taken into a Luzex image analyzer through a video camera, the maximum length and projected area of 100 particles are determined and the average value thereof is calculated using formula (E) described above to obtain the SF1.

[Small-Diameter Side Number Average Particle Site Distribution Index]

The small-diameter side number average particle size distribution index of the toner according to the exemplary embodiment is preferably 1.30 to 1.70, more preferably 1.32 to 1.65, and even more preferably 1.35 to 1.60.

Various average particle diameters and various particle size distribution indexes of the toner are measured using the COULTER MULTISIZER-II MODEL (manufactured by Beckman Coulter, Inc.) using ISOTON-II (manufactured by Beckman Coulter, Inc.) as the electrolytic solution. Various average particle diameters and various particle size distribution indexes of the toner mother particles are measured using the COULTER MULTISIZER-II MODEL (manufactured by Beckman Coulter, Inc.), and using ISOTON-II (manufactured by Beckman Coulter, Inc.) as the electrolytic solution.

In the measurement, 0.5 mg to 50 mg or less of a measurement, sample is added into 2 ml of a 5% aqueous solution of a surfactant (sodium alkylbenzenesulfonate is preferable) as a dispersing agent. The resultant is added into 100 ml or more to 150 ml or less of an electrolyte solution.

The electrolyte solution in which the sample is suspended is subjected to a 1 minute dispersion treatment in an ultrasonic disperser, and the particle size distribution of particles with a particle diameter in a range of 2 μg or more to 60 μm or less is measured using the Coulter Multisizer-II model using an aperture of 100 μm as the aperture diameter. The number of particles to be sampled is 50,000.

The smaller diameter side number average particle size distribution index (also referred to as “lower GSD”) is the ratio of the 50% particle diameter value and the 16% particle diameter value of the number average particle diameter.

The 50% particle diameter value and the 16% particle diameter value of the number average particle diameter are particle diameters at 50% and 16% when depicting the number cumulative distribution curve from the small particle diameter side with respect to each divided particle site range.

<Method for Preparing Toner>

The method for preparing the electrostatic charge image developing toner according to the exemplary embodiment is not particularly limited, and the toner may be prepared by a dry method such as a kneading and pulverizing method, or a wet method such as an emulsion aggregation method and a suspension polymerization method, known in the art. Among these methods, the kneading and pulverizing method and emulsion aggregation method are preferable.

(2) Electrostatic Charge Image Developer

The electrostatic charge image developing toner according to the exemplary embodiment is suitable for use as an electrostatic charge image developer.

The electrostatic charge image developer according to the exemplary embodiment is not particularly limited as long as the electrostatic charge image developing toner according to the exemplary embodiment is contained therein and may take an appropriate component composition according to the purpose. The electrostatic charge image developing toner according to the exemplary embodiment is prepared as a single-component electrostatic charge image developer when used alone and, in addition, is prepared as a two-component electrostatic charge image developer when used in combination with a carrier.

The electrostatic charge image developing toner according to the exemplary embodiment may also be applied as a single-component developer to a method, in which a charged toner is formed by frictional electrification with a developing sleeve or a charging member to carry out development in response to the electrostatic charge image.

In the exemplary embodiment, the developing method is not particularly limited; however, a two-component developing method is preferable, and the electrostatic charge image developer according to the exemplary embodiment preferably contains a carrier.

The carrier is not particularly limited; however, examples of the core material of the carrier include magnetic metals such as iron, steel, nickel, and cobalt, alloys of the above and manganese, chromium, rare earth, and the like, and magnetic oxides such as ferrite, magnetite, and the like; however, from the point of view of the core material surface properties and the core material resistance, an alloy of ferrite, in particular, manganese, lithium, strontium, magnesium, or the like is preferable.

The carrier used in the exemplary embodiment is preferably a carrier in which a resin is coated on a core material surface. The resin is not particularly limited and may be appropriately selected according to the purpose. In addition, in the film coated on the resin, the resin particles and/or conductive particles are preferably dispersed in the resin. Examples of rosin particles include thermoplastic resin particles, thermosetting resin particles, and the like.

The method for forming the coated, film is not particularly limited; however, examples thereof include a method in which a coated film-forming solution including the resin particles and/or the conductive particles such as cross-linked resin particles, and the resins such as styrene-acrylic resin, fluorine resin, and silicone resin as a matrix resin in a solvent is used, or the like.

Specifically, examples thereof include an immersion method in which the carrier core material is immersed in a coated film-forming solution, a spraying method in which a coated film-forming solution is sprayed on the surface of a carrier core material, a kneader coater method in which a liquid for forming a coated film is mixed in a state where the carrier core material is made to float on fluid air and the solvent is removed, and the like. Among the above, in the exemplary embodiment, the kneader coater method is preferable.

The average particle diameter of the carrier and the core material is preferably 10 μm or more to 100 μm or less, and more preferably 20 μm or more to 80 μm or less.

The mixing ratio of the toner and the carrier in the electrostatic charge image developer according to the exemplary embodiment is preferably 1 part by weight to 30 parts by weight of toner, and mere preferably 3 parts by weight to 20 parts by weight of toner with respect to 100 parts by weight of the carrier. In addition, the method for preparing the electrostatic charge image developer is not particularly limited; however, examples thereof include a method for mixing in a v-blender, or the like.

(3) Image Forming Method

The electrostatic charge image developing toner according to the exemplary embodiment is used in an image forming method for an electrostatic image developing system (electrophotographic system).

The image forming method according to the exemplary embodiment is an image forming method using an electrostatic charge image developing toner according to the exemplary embodiment; however, the image forming method according to the exemplary embodiment is preferably a method including a latent image forming step for forming an electrostatic charge image on the surface of an image holding member, a developing step for forming a toner image by developing an electrostatic charge image formed on the image holding member surface using a developer including a toner, a transfer step for transferring the toner image onto a transfer medium surface, and a fixing step for fixing the toner image transferred to the transfer medium surface, in which the electrostatic charge image developing toner according to the exemplary embodiment is used as the toner, or the electrostatic charge image developer according to the exemplary embodiment is used as the developer.

In addition, after the fixing step described above, it is preferable to include a cleaning step for cleaning the developer remaining on the image holding member using a cleaning blade.

Each of the steps is itself a general step. The image forming method according to the exemplary embodiment may be implemented using an image forming apparatus such as a copy machine, a facsimile machine, or the like itself known in the art.

The electrostatic charge image forming step is a step of forming an electrostatic charge image on an image holding member (photoconductor).

The developing step is a step for forming a toner image by developing the electrostatic charge image using a developer layer on a developer holding member. The developer layer is not particularly limited as long as it is a developer including the electrostatic charge image developing toner according to the exemplary embodiment.

The transfer step is a step of transferring the toner image on a transfer medium. In addition, examples of the transfer medium in the transfer step may include a recording medium such as an intermediate transfer member or paper.

In the fixing step, for example, examples include a method for forming a transfer image by fixing a toner image transferred onto the transfer paper using a heating roller fixing machine in which the temperature of the heating roller is set to a fixed temperature.

The cleaning step preferably includes a step of removing the electrostatic charge image developer retraining on the image holding member using a cleaning blade.

Preferable examples of the material, of the cleaning blade include urethane rubber, neoprene rubber, silicone rubber, and the like.

As the recording medium, it is possible to use a known recording medium and examples thereof include paper used in electrophotographic copiers, printers, and the like, OHP sheets, and the like, and, for example, it may suitably use coated paper where the surface of normal paper is coated with a resin or the like, art paper for printing, or the like.

The image forming method according to the exemplary embodiment may further have an aspect which also includes a recycling step. The recycling step is a step for moving the electrostatic charge image developing toner recovered in the cleaning step to a developer layer. The image forming method of the aspect including the recycling step is implemented, using an image forming apparatus such as a toner recycling system-type copier or facsimile machine. In addition, an aspect in which the cleaning step is omitted and the toner is recovered at the same time as the development may foe applied to a recycling system.

(4) Image Forming Apparatus

The image forming apparatus according to the exemplary embodiment has a developing unit for forming a toner image by developing the electrostatic charge image using the electrostatic charge image developer according to the exemplary embodiment; however, the image forming apparatus according to the exemplary embodiment is preferably an apparatus which has an image holding member, a charging unit for charging the image holding member, an exposure unit for forming an electrostatic charge image on a surface of the image holding member by exposing the charged image holding member, a developing unit for forming a toner image by developing the electrostatic charge image using a developer which includes a toner, a transfer unit which transfers the toner image from the image holding member to a transfer medium surface, and a fixing unit for fixing a toner image transferred to the transfer medium surface, in which the toner is the electrostatic charge image developing toner according to the exemplary embodiment or the developer is the electrostatic charge image developer according to the exemplary embodiment.

In addition, the image forming apparatus according to the exemplary embodiment is preferably an apparatus which further has a cleaning unit for cleaning the image holding member using a cleaning blade as one cleaning unit.

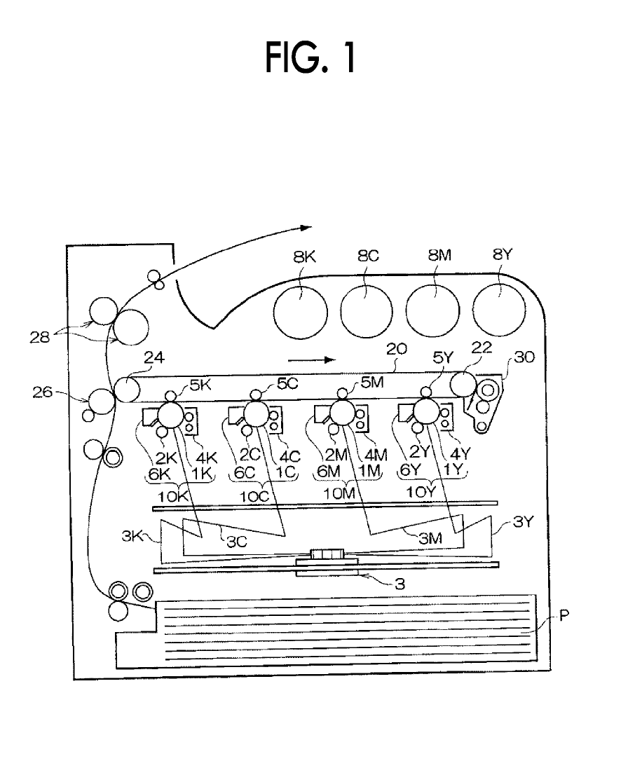

FIG. 1 is a schematic configuration diagram which shows a quadruple, tandem system color image forming apparatus. The image forming apparatus shown in FIG. 1 is provided with first to fourth image forming units 10Y, 10M, 10C, and 10K (image forming unit) of an electrophotographic system, which output images of each color of yellow (Y), magenta (M), cyan (C), and black (K) based on the color-separated image data. These image forming units (hereinafter, may be simply referred to as “units”) 10Y, 10M, 10C, and 10K are arranged to be separated by a predetermined distance from each other in the horizontal direction. These units 10Y, 10M, 10C, and 10K may be process cartridges which are detachable from the image forming apparatus.

Above each of unit 10Y, 10M, 10C, and 10K in the diagram, an intermediate transfer belt 20 is extended as an intermediate transfer member through each of the units. The intermediate transfer belt 20 is provided to be wrapped around a driving roller 22 and a support roller 24 in contact with the inner surface of the intermediate transfer belt 20, which are arranged separately from, each other in the direction from left to right in the diagram, and travels in a direction from the first unit 10Y toward the fourth unit 10K. Force is applied to the support roller 24 in the direction away from the driving roller 22 by a spring or the like which is not shown and tension is applied to the intermediate transfer belt 20 wound around both rollers. In addition, a cleaning unit 30 for the intermediate transfer member is provided on the image holding member side surface of the intermediate transfer belt 20 to oppose the driving roller 22. In addition, it is possible to supply toner of four colors of yellow, magenta, cyan, and black stored in the toner cartridges 8Y, 8M, 8C, and 8K to each of developing machines (developing unit) 4Y, 4M, 4C, and 4K of each unit 10Y, 10M, 10C, and 10K.

Since the first to fourth units 10Y, 10M, 10C, and 10K described above have the same configuration, here, description will be given of the first unit 10Y which forms a yellow image and which is disposed on the upstream side in the traveling direction of the intermediate transfer belt as a representative. By applying the reference numerals referring to magenta (M), cyan (C), and black (K) to the portions equivalent to the first unit 10Y instead of yellow (Y), description of the second to fourth units 10M, 10C, and 10K may be omitted.

The first unit 10Y has a photoreceptor 1Y which acts as an image holding member (photoreceptor). A charging roller (charging apparatus, charging unit) 2Y for charging the surface of the photoreceptor 1Y to a predetermined potential, an exposure apparatus (exposure unit) 3 for forming an electrostatic image by exposure using a laser beam 3Y based on image signals in which the charged surface is color-separated, a developer (developing unit) 4Y which develops an electrostatic image by supplying the charged toner to the electrostatic image, a primary transfer roller (primary transfer unit) 5Y which transfers the developed toner image onto, the intermediate transfer belt 20, and a cleaning apparatus (cleaning unit) 6Y which removes the toner remaining on the surface of the photoreceptor 1Y after the primary transfer using a cleaning blade, are arranged in order on the periphery of the photoreceptor 1Y.

The primary transfer roller 5Y is disposed on the inner side of the intermediate transfer belt 20 and provided at a position opposing the photoreceptor 1Y. Furthermore, a bias power supply (not shown) which applies a primary transfer bias is connected with each of the primary transfer rollers 5Y, 5M, 5C, and 5K. Each bias power supply varies the transfer bias which is applied to each of the primary transfer rollers under the control of a control unit which is not shown in the diagram.

Description will be given below of an operation for forming a yellow image in the first unit 10Y. First, prior to the operation, the surface of the photoreceptor 1Y is charged by the charging 2Y. A laser beam 3Y is output to the surface of the charged photoreceptor 1Y via an exposure apparatus 3 according to yellow image data sent from the control unit which is not shown in the diagram. The photosensitive layer on the surface of the photoreceptor 1Y is irradiated with the laser beam 3Y and, due to this, an electrostatic image of a yellow print pattern is formed on the surface of the photoreceptor 1Y. In this manner, the electrostatic image formed on the photoreceptor 1Y is rotated up to a predetermined development position in accordance with the traveling of the photoreceptor 1Y. Then, in this developing position, the electrostatic image on the photoreceptor 1Y is made visible (developed image, toner image) by a developing machine 4Y.

In the developing machine 4Y, for example, an electrostatic charge image developer which includes at least the yellow toner according to the exemplary embodiment and the carrier is stored. Then, oy the surface ot the photoreceptor 1Y passing through the developer machine 4, yellow toner is electrostatically attached to the neutralized latent image unit on the surface of the photoreceptor 1Y and the latent image is developed using yellow toner. Subsequently, the photoreceptor 1Y on which the yellow toner image is formed continues to travel at a predetermined Speed and the toner image developed on the photoreceptor 1Y is fed to a predetermined primary transfer position.

When the yellow toner image on the photoreceptor 1Y is fed to the primary transfer, a primary transfer bras is applied to the primary transfer roller 5Y, electrostatic force from the photoreceptor 1Y toward the primary transfer roller 5Y acts on the toner image, and the toner image or the photoreceptor 1Y is transferred onto the intermediate transfer belt 20. On the other hand, the toner remaining on the photoreceptor 1Y is removed and recovered by a cleaning unit 6Y having a cleaning blade.

In addition, the primary transfer bias applied to the primary transfer rollers 5M, 5C, and 5K after the second unit 10M is also controlled by the first unit. In this manner, in the first unit 10Y, the intermediate transfer belt 20 to which the yellow toner image is transferred in order through the second to fourth unit 10M, 10C, and 10K, and toner images of each color are superimposed and transferred in a multiplex manner.

The intermediate transfer belt 20 to which toner images of four colors are transferred in a multiplex manner through the first to fourth units reaches a secondary transfer unit formed from the intermediate transfer belt 20, the support roller 24 in contact with the intermediate transfer belt inner surface, and a secondary transfer roller (secondary transfer unit) 26 arranged on the image holding surface side of the intermediate transfer belt 20. On the other hand, the recording sheet (transfer medium) P is put via the supply mechanism at a predetermined timing in an interval pressed by the secondary transfer roller 26 and the intermediate transfer belt 20, a secondary transfer bias is applied to the support roller 24, and the toner image on the intermediate transfer belt 20 is transferred onto the a recording sheet P.

After this, the recording sheet P is put into the contact units (nipping units) of a pair of fixing rollers in the fixing apparatus (roll-type fixing unit) 28, the toner image is heated, a color-superimposed toner image is melted, and fixed on the recording sheet P. The recording sheet P on which the fixing of the color image is completed is discharged toward a discharge unit and the series of color image forming operations is finished.

The image forming apparatus according to the exemplary embodiment is not particularly limited as long as the image forming apparatus includes at least the image holding member, the charging unit, the exposure unit, the development unit, the transfer unit, and the cleaning unit as described above; however, as necessary, a fixing unit, a neutralizing unit, or the like may be included.

In the transfer unit, the transferring may be performed two times or more using the intermediate transfer member. In addition, as the transfer medium in the transfer unit, it may exemplify a recording medium such as an intermediate transfer member or a recording medium such as a sheet.

The image holding member and each of the units may preferably use the configuration described in each step of the image forming method. Each of the units may use a known unit in the image forming apparatus. In addition, the image forming apparatus according to the exemplary embodiment may include a unit, apparatus, or the like other than the configuration described above. In addition, in the image forming apparatus according to the exemplary embodiment, the plural units described above may operate at the same time.

In addition, the image forming apparatus according to the exemplary embodiment is preferably provided with a cleaning unit which removes the electrostatic charge image developer remaining on the image holding member using a cleaning blade.

(5) Toner Cartridge, Developer Cartridge, and Process Cartridge

The toner cartridge according to the exemplary embodiment is a toner cartridge which stores the electrostatic charge image developing toner according to the exemplary embodiment.

The developer cartridge according to the exemplary embodiment is a developer cartridge which stores the electrostatic charge image developer according to the exemplary embodiment.

In addition, the process Cartridge according to the exemplary embodiment is a process cartridge which stores the electrostatic charge image developer according to the exemplary embodiment and is provided with a developer holding member which holds and feeds the electrostatic charge image developer, and is preferably a process cartridge provided with a developing unit for forming a toner image by developing an electrostatic charge image formed on an image holding member surface using the electrostatic charge image developing toner or the electrostatic charge image developer, and at least one selected from a group formed of a charging unit for charging the image holding member and the image holding member surface, and a cleaning unit for removing toner remaining on the image holding member surface, and which stores the electrostatic charge image developing toner according to the exemplary embodiment or an electrostatic charge image developer according to the exemplary embodiment.

The toner cartridge according to the exemplary embodiment is preferably detachable from the image forming apparatus. That is, the toner cartridge acceding to the exemplary embodiment, which stores the toner according to the exemplary embodiment is suitably used in an image forming apparatus having a configuration in which the toner cartridge is detachable. The toner cartridge according to the exemplary embodiment may have a container which contains the toner according to the exemplary embodiment.

The developer cartridge according to the exemplary embodiment is not particularly limited as long as the developer cartridge contains an electrostatic charge image developer including the electrostatic charge image developing toner according to the exemplary embodiment. For example, the developer cartridge is detachable from an image forming apparatus provided with a developing unit, and stores an electrostatic charge image developer including an electrostatic charge image developing toner according to the exemplary embodiment as a developer to be supplied to the developing unit.

In addition, the developer cartridge maybe a cartridge storing a toner and a carrier, or may be a cartridge in which a cartridge storing a toner alone and a cartridge storing a carrier alone are separate.

The process cartridge according to the exemplary embodiment is preferably detachable from the image forming apparatus.

In addition, the process cartridge according to the exemplary embodiment may include other members such as a neutralizing unit according to necessity.

The toner cartridge and process cartridge may adopt a known configuration.

### Example

More detailed description will be given below of the exemplary embodiment using Examples and Comparative Examples; however, the exemplary embodiment is not limited to the Examples below. Unless otherwise stated, “parts” and “%” represent “parts by weight” and “weight %”.

<Preparation of Polyester Resin (A1)>
Polycarboxylic acid compound

Terephthalic acid: 90 mol-equivalent

Sodium 5-sulfoisophthalate: 1 mol-equivalent
Polyol Compound

Ethylene glycol: 50 mol-equivalent

1,5-pentanediol: 50 mol-equivalent
Epoxy compound

Polyepoxy compound (manufactured by DIC (KK), Epicion N-695, Cresol novolak type epoxy resin, Epoxy equivalent: 209 to 219 g/eq): 9 mol-equivalent

A total of three parts toy weight of the polycarboxylic acid compound, the polyol compound, and the epoxy compound described above were introduced into a flask equipped with a stirring device, a nitrogen inlet tube, a temperature sensor, and a rectification column, the temperature was raised to 190° C. over a period of one hour, a catalyst Ti (OBu)₄ (titanium tetrabutoxide, 0.003 weight % with respect to the total amount of the polyvalent carboxylic acid component) was introduced after confirming that the inside of the reaction system was stirred.

Furthermore, the temperature was slowly increased from the same temperature up to 245° C. while distilling off the generated water and a polymerization reaction was carried out following a dehydration condensation reaction for six hours. After that, the temperature was lowered to 235° C., reaction was carried out under a reduced pressure of 30 mmHg for two hours, and a polyester resin (A1) was obtained. When the molecular weight of the resin of the obtained polyester resin (A1) was measured by gel permeation chromatography (GPC), the weight average molecular weight was 80,000. In addition, as the result of the measurement of the thermal characteristics of the resin obtained by the differential scanning calorimeter, the Tg (secondary transition temperature) was 61° C.

Furthermore, as a result of measuring the softening temperature of the obtained resin ((½) drop temperature of the flow tester Tm) using a KOKA TYPE FLOW TESTER [CFT-500] (manufactured by Shimadou Corporation) under the conditions of a diameter of 1 mm of the pores of the die, a pressure of 10 kg/cm², a temperature increase rate of 3° C./min, as a temperature corresponding to ½ of the height of the end point from the flow start point at the time when a sample of 1 cm³ melted and ran off, Tm was 145° C.

<Preparation of Polyester Resin (A2)>

A polyester resin (A2) was prepared using the same method as the polyester (A1) except that the content of the polyvalent carboxylic acid compound was changed as described in the following Table 1 and an epoxy compound was not used. The values described in Table 1 represent the molar equivalent amount of the active component of each compound.

The weight average molecular weight was 82,000, Tg was 62° C., and Tm was 146° C.

<Preparation of Polyester Resin (A3)>

A polyester resin (A3) was prepared using the same method as the polyester resin (A1) except that the polyol compound was changed as described in the following Table 1.

In Table 1, the EO 2 mole adduct of BPA represents an ethylene oxide 2 mol adduct of bisphenol A and the PO 2 mole addict of BPA represents a propylene oxide 2 mol adduct of bisphenol A.

The weight average molecular weight was 83,000, Tg was 61° C., and Tm was 147° C.

<Preparation of Polyester Resin (A4)>

A polyester resin (A4) was prepared using the same method as the polyester resin (A1) except that the polyol compound was changed as described in the following Table 1.

The weight average molecular weight was 79,000, Tg was 60° C., and Tm was 143° C.

<Preparation of Polyester Resin (A5)>

A polyester resin (A5) was prepared using the same method as the polyester resin (A1) except that the polyol compound was changed as described in the following Table 1.

The weight average molecular weight was 80,000, Tg was 61° C., and Tm was 144° C.

<Preparation of Polyester Resin (A6)>

A polyester resin (A6) was prepared using the same method as the polyester resin (A1) except that the polyol compound was changed as described in the following Table 1.

The weight average molecular weight was 81,000, Tg was 61° C., and fm was 145° C.

<Preparation of Polyester Resin (A7)>

A polyester resin (A7) was prepared using the same method as the polyester resin (A1) except that the polyol compound was changed as described in the following Table 1.

The weight average molecular weight was 80,000, Tg was 61° C., and Tm was 148° C.

TABLE 1

| | | Polyester Resin | | | | | | |
|---|---|---|---|---|---|---|---|---|
| | | A1 | A2 | A3 | A4 | A5 | A6 | A7 |
| Poly- | Terephthalic acid | 90 | 98 | 90 | 90 | 90 | 90 | 90 |
| carboxylic | Sodium | 1 | 2 | 1 | 1 | 1 | 1 | 1 |
| acid | 5-sulfoisophthalate | | | | | | | |
| Polyol | Ethylene glycol | 50 | 50 | 49 | 45 | 40 | 49 | — |
| | 1,5-pentanediol | 50 | 50 | 50 | 50 | 45 | — | — |
| | o-xylylene glycol | — | — | — | 5 | 15 | — | — |
| | Neopentyl glycol | — | — | — | — | — | 50 | — |
| | EO 2 mole adduct | — | — | 0.5 | — | — | 0.5 | 34 |
| | of BPA | | | | | | | |
| | PO 2 mole adduct | — | — | 0.5 | — | — | 0.5 | 66 |
| | of BPA | | | | | | | |
| Epoxy | Polyepoxy compound | 9 | — | 9 | 9 | 9 | 9 | 9 |
| compound | | | | | | | | |

<Preparation of Graft Polymer (B1) including Polyolefin Chain and Vinyl Resin Chain>

80 parts of xylene, 10 parts of polypropylene wax (manufactured by Mitsui Chemicals, Inc., product name: NP105), and 10 parts of polyethylene wax (manufactured by Clariant, product name PB 520) were introduced into a stainless steel pressure reactor and thoroughly purged with nitrogen in this container, after which the temperature was increased up to 170° C. while sealed. Next, a mixture of 5 parts of acrylonitrile, 65 parts of styrene, and 10 parts of n-butyl acrylate was added dropwise over a period of 4 hours along with 1 part of di-t-butyl peroxide which is a peroxide initiator, further held for one hour at 170° C., and a xylene solution of the mixture of a graft polymer and a styrene (meth)acrylic resin was obtained. The xylene was distilled off from the xylene solution of the obtained mixture to form a solid, the solid was dissolved in toluene of an amount five times greater than the weight of the solid, the soluble part was added dropwise into acetone ten times greater than the toluene, and, by drying the obtained precipitate, a graft polymer (B1) including a polyolefin chain and a vinyl resin chain was obtained by fractionating.

<Preparation of Graft Polymer (B2) including Polyolefin Chain and Vinyl Resin Chain>

A graft polymer (B2) including a polyolefin chain and a vinyl resin chain was prepared using the same method as the graft polymer (B1) including the polyolefin chain and the vinyl resin chain except that the acrylonitrile was changed to methacrylonitrile.

### Example 1

<Preparation of Toner T1>

[Preparation of Toner Mother Particles 1]
Polyester resin A1: 86 parts
Polyethylene wax C1 (manufactured by Toyo Adl Corp., PW725): 3 parts
Graft polymer B1 including polyolefin chain and vinyl resin chain: 3 parts
Carbon black (manufactured by Cabot Corp., Regal330): 7 parts
Charge-controlling agent (manufactured by Orient Chemical Industries Co., Ltd., BONTRON P-51): 1 part

After pre-mixing the above components in a HENSCHEL MIXER, a kneaded product was obtained, by kneading in a twin-screw continuous kneader having a screw configuration, under kneading conditions of a supply amount of 15 kg/h, and a kneading temperature of 120° C. After pulverizing the kneaded product using an IDS-2 TYPE COLLISION PLATE TYPE PULVERIZER (manufactured by Nippon Pneumatic Mfg. Co., Ltd.), by using a pneumatic ELBOW JET CLASSIFIER (manufactured by MATSUBO Corporation) and adjusting and changing the classification edge with a processing rate: of 1.5 kg/h, fine powder and coarse powder were removed and toner mother particles 1 were obtained.

[Preparation of Toner T1]

100 parts of the obtained toner mother particle 1 and 1 part of silica particles (manufactured by Nippon Aerosil Co., Ltd., R371, volume average particle diameter 16 nm) were mixed for 60 seconds at 6, 000 rpm using a sample mill and, after mixing for 15 minutes at a peripheral speed of 20 m/s using a HENSCHEL MIXER, the coarse particles were removed using a sieve with a mesh of 45 μm to obtain a toner T1.

<Preparation of Carrier>

[Formation of Core Material]

A core material was formed using the following methods.

500 parts of spherical magnetite particle powder having a volume average particle diameter of 0.50 μm were introduced into a HENSCHEL MIXER and, after sufficiently stirring, 5.0 parts of a titanate coupling agent were added, the temperature was raised up to 100° C., spherical magnetite particles coated with a titanate coupling agent were obtained by mixing and stirring for 30 minutes. Next, 6.25 parts of phenol, 9.25 parts of 35% formalin, 500 parts of the magnetite particles described above, 6.25 parts of 25% ammonia water, and 425 parts of water were added to a four-necked flask, and the resultant was mixed and stirred. Next, while stirring, the temperature was increased up to 85° C. for 60 minutes, reaction was carried out. for 120 minutes at the same temperature, after that, the temperature cooled to 25° C., 500 ml of water was added, after that, the supernatant was removed and the precipitate was washed with water. The resultant was dried under reduced pressure at 150° C. or more to 180° C. or less and core material particles with a volume average particle diameter of 30 μm were obtained.

[Formation of Resin Layer (Formation of Recessed Portion)]

A resin layer having a recessed portion was formed on the surface of the core material using the following method. 12 parts of polytetrafluoroethylene: resin powder and 0.86 parts of silicon dioxide powder (average particle diameter 120 nm) subjected to a surface treatment in a polymethyl methacrylate resin were mixed and stirred for 20 minutes in a V-blender. 400 parts of the obtained mixed powder and the core material particles were added to a dry hybrid processing apparatus NOBIRUTA NOB130 (manufactured by Hosokawa Micron Co., Ltd.), and processing was carried out at 1,000 rpm for 30 minutes. The obtained powder and 1,000 parts of acetone were added to a 2 L container with a stirring blade and, after stirring for 30 minutes at 150 rpm, solid-liquid separation was carried out using a filter paper with a mesh of 10 μm. The resultant was redispersed in 1,000 parts of acetone and, after stirring for 30 minutes at 150 rpm, solid-liquid separation was carried out again using a filter paper with a mesh of 10 μm. Next, vacuum drying was carried out for 2 hours and the resultant was passed through a mesh with 75 μm openings to obtain a 35 μm carrier.

[Preparation of Ferrite Carrier]

Appropriate amounts of each raw material, were mixed such as to be 30 mol % in terms of MnO, 9.5 mol % in terms of MgO, 60 mol % in terms of Fe₂O₃, and 0.5 mol % in terms of SrO, water was added, pulverizing, mixing, and drying were carried out in a wet ball mill for 10 hours, the resultant was held at 900° C. for four hours, after that, a slurry subjected to pulverizing for 24 hours in a wet ball mill was granulated and dried, the resultant was held for 6 hours at 1,250° C. in a 2% oxygen concentration atmosphere, after that, pulverizing and particle size adjustment were performed, and manganese-magnesium-strontium ferrite particles A were obtained.

100 parts of the manganese-magnesium-strontium ferrite particles A and 25 parts of a resin coating layer forming liquid A-1 were added to a vacuum degassing kneader and, after stirring for 30 minutes at 90° C., the resultant was dried at −96 kPa for 30 minutes. Next, 102 parts of the magnetic particles and 15 parts of the resin coating layer forming solution B-1 were added into the vacuum degassing kneader and, after stirring for 30 minutes at 90° C., stirring was carried out for 5 minutes at −65 kPa and for 3 minutes at −70 kPa, then degassing and drying were carried out under further reduced pressure. After cooling the resultant, coarse powder was removed by aggregation with a sieve with a mesh, of 75 μm and a carrier with a volume average particle diameter of 50 μm was obtained.

<Preparation of Developer>

The toner and the carrier were added into a V-blender at a ratio of 5:95, stirring was carried out for 20 minutes, and the developer of Example 1 was prepared.

<Evaluation>

[Normal Temperature and Normal Humidity Aggregation Degree, Measurement of Surface Exposure Ratio, and Small-diameter Side Number Average Particle Size Distribution Index (lower GSD)]

Using the methods described above, the normal temperature and normal humidity aggregation degree (normal temperature and normal humidity aggregation degree) of the toner mother particles, the surface exposure ratio (surface exposure ratio) of the polyethylene wax, and the small-diameter side number average particle size distribution index (lower GSD)] were measured and the measurement results are shown in Table 2.

[Machine Contamination Determination]

After printing 20,000 sheets using DOCU PRINT P218 manufactured by Fuji Xerox Co., Ltd. employing a two-component contact development system, under a high-temperature and high-humidity environment (28° C., 85%) and using a P sheet (black-and-white copier/printer paper) (manufactured by Fuji Xerox Co., Ltd,) as paper, evaluation, which checked the process units around the cartridge, the toner ejection onto the feeding path, and the contamination, was performed. Evaluation was performed in accordance with the following evaluation criteria and the results are shown in Table 2.

A: there were absolutely no problems at this level

B: faint contamination may be confirmed at this level, but without problems

C: contamination may be confirmed at this level, but without problems for practical use

D: contamination was caused at this level and there were problems for practical use

[Fixing Property Determination]

Using plain paper (P sheet), a one-inch square (2.54 cm×2.54 cm) image was formed such that the attachment amount of the toner was 0.6 mg/cm².

Image defects before and after rubbing the obtained image back and forth 10 times with cotton were determined. Evaluation was performed in accordance with the following evaluation criteria and the results are shown in Table 2.

A: There were absolutely no problems at this level

B: faint roughening may be confirmed at this level, but without problems

C: image roughening may be confirmed at this level, but without problems for practical use

D: image roughening was caused at this level and there were problems for practical use.

### Examples 2 to 10 and Comparative Examples 3 to 4

Developers were prepared in the same manner as in Example 1 except that the polyester resin A1, the polyethylene wax C1, the graft polymer E1 including the polyolefin chain and the vinyl resin chain, the supply amount, and the kneading temperature used in Example 1 were changed as described in Tables 2 to 4, and evaluation was carried out. The evaluation results are shown in Table 2 to Table 4.

In Table 2, “—” in the description indicates that the appropriate component is not contained.

### Examples 11 to 14

Developers were prepared in the same manner as in Example 1 except that the classifying edge in the pulverizing classifier was adjusted, and evaluation was carried out. The evaluation results are shown in Table 3.

### Example 15

Developers were prepared in the same mariner as in Example 1 except that the usage amounts of the components used in the Preparation of the toner mother particles were changed as follows, and evaluation was carried out. The evaluation results are shown in Table 3.
Polyester resin A1: 86 parts
Polyethylene wax C1 (PW725, manufactured by Toyo Adl Corp.): 3 parts
Graft polymer including a polyolefin chain and a vinyl resin chain B1: 3 parts
Carbon black (manufactured by Cabot Corp., Regal330): 7 parts
Charge-controlling agent (manufactured by Orient Chemical Industries Co., Ltd., BONTRON P-51): 1 part

### Example 16

Developers were prepared in the same manner as in Example 1 except that the usage: amounts of the components used in the preparation of the toner mother particles were changed as follows, and evaluation was carried out. The evaluation results are shown in Table 3.
Polyester resin A1: 86 parts
Polyethylene wax C1 (PW725, manufactured by Toyo Adl Corp.) 3 parts
Graft poly filer including a polyolefin chain and a vinyl resin chain B1: 3 parts
Carbon black (manufactured by Cabot Corp., Regal330): 7 parts
Charge-controlling agent (manufactured by Orient Chemical Industries Co., Ltd., BONTRON P-51): 1 part

### Example 17

Developers were prepared in the same manner as in Example 1 except that the usage amounts of the components used in the preparation of the toner mother particles were changed as follows, and evaluation was carried out. The evaluation results are shown in Table 3.
Polyester resin A1: 86 parts
Polyethylene wax C1 (PW725, manufactured by Toyo Adl Corp.): 3 parts
Graft polymer including a polyolefin chain and a vinyl resin chain B1: 3 parts
Carbon black (manufactured by Cabot Corp., Regal330): 7 parts
Charge-controlling agent (manufactured by Orient Chemical Industries Co., Ltd., BONTRON P-51): 1 part

### Example 18

Developers were prepared in the same manner as in Example 1 except that the conditions in the pulverizing classifier were set to 0.8 times the processing rate and the classification edge was adjusted, and evaluation was carried out.

### Example 19

Developers were prepared in the same manner as in Example 1 except that the conditions in the pulverizing classifier were set to 0.5 times the processing rate and the classification edge was adjusted, and evaluation was carried out.

### Example 20

Developers were prepared in the same manner as in Example 1 except that the conditions in the pulverizing classifier were set to 1.7 times the processing rate and the classification edge was adjusted, and evaluation was carried out.

### Example 21

Developers were prepared in the same manner as in Example 1 except that the conditions in the pulverizing classifier were set to 2.3 times the processing rate and the classification edge was adjusted, and evaluation was carried out.

### Example 22

Developers were prepared in the same manner as in Example 1 except that the usage amounts of the components used in the preparation of the toner mother particles were changed as follows, and evaluation was carried out. The evaluation results are shown in Table 4.
Polyester resin A1: 85 parts
Polyethylene wax C1 (PW725, manufactured by Toyo Adl Corp.): 4 parts
Grart polymer including a polyolefin chain and a vinyl resin chain B1: 3 parts Carbon black (manufactured by Cabot Corp,, Regal330): 7 parts
Charge-controlling agent (manufactured by Orient Chemical Industries Co., Ltd., BONTRON P-51): 1 part

### Example 23

Developers were prepared in the same manner as in Example 1 except that the usage amounts of the components used in the preparation of the toner mother particles were changed as follows, and evaluation was carried out. The evaluation results are shown in Table 4.
Polyester resin A1: 87 parts
Polyethylene wax C1 (PW725, manufactured by Toyo Adl Corp.): 2 parts
Graft polymer including a polyolefin chain and a vinyl resin chain B1: 3 parts
Carbon black (manufactured by Cabot Corp., Regal330): 7 parts
Charge-controlling agent (manufactured by Orient Chemical Industries Co., Ltd., BONTRON p-51): 1 part

### Comparative Example 1

Developers were prepared in the same manner as in Example 1 except that the usage amounts of the components used: in the preparation of the toner mother particles were changed as follows, and evaluation was carried out. The evaluation results are shown in Table 4.
Polyester resin A1; 80 parts
Polyethylene wax C1 (PW725, manufactured by Toyo Adl Corp.): 3 parts
Craft polymer including a polyolefin chain and a vinyl resin chain B1: 9 parts
Carbon black (manufactured by Cabot Corp., Regal330): 7 parts
Charge-controlling agent (manufactured by Orient Chemical Industries Co., Ltd., BONTRON P-51): 1 part

### Comparative Example 2

Developers were prepared in the same manner as in Example 1 except that the usage amounts of the components used in the preparation of the toner mother particles were changed as follows, and evaluation was carried out. The evaluation results are shown in Table 4.
Polyester resin A1: 88 parts
Polyethylene wax C1 (PW725, manufactured by Toyo Adl Corp.): 3 parts
Graft polymer including a polyolefin chain and a vinyl resin chain B1: 1 part
Carbon black (manufactured by Cabot Corp., Regal330): 7 parts
Charge-controlling agent (manufactured by Orient Chemical industries Co., Ltd., BONTRON P-51): 1 part

TABLE 2

| | Exam- | Exam- | Exam- | Exam- | Exam- | Exam- | Exam- | Exam- | Exam- |
|---|---|---|---|---|---|---|---|---|---|
| | ple 1 | ple 2 | ple 3 | ple 4 | ple 5 | ple 6 | ple 7 | ple 8 | ple 9 |
| Toner | T1 | T2 | T3 | T4 | T5 | T6 | T7 | T8 | T9 |
| Polyester resin | A1 | A2 | A3 | A4 | A5 | A6 | A1 | A1 | A1 |
| Graft polymer including polyolefin | B1 | B1 | B1 | B1 | B1 | B1 | B2 | B1 | B1 |
| chain and vinyl resin chain | | | | | | | | | |
| Polyethylene wax | C1 | C1 | C1 | C1 | C1 | C1 | C1 | C2 | C1 |
| Supply rate (kg/h) | 15 | 15 | 15 | 15 | 15 | 15 | 15 | 15 | 15 |
| Preparation temperature (° C.) | 120 | 120 | 120 | 120 | 120 | 120 | 120 | 120 | 90 |
| Normal temperature and normal | 80 | 80 | 80 | 80 | 80 | 80 | 80 | 80 | 70 |
| humidity aggregation degree | | | | | | | | | |
| Small-diameter side number average | 1.41 | 1.41 | 1.41 | 1.41 | 1.41 | 1.41 | 1.41 | 1.41 | 1.40 |
| particle size distribution index | | | | | | | | | |
| (lower GSD) | | | | | | | | | |
| Surface exposure ratio | 25 | 25 | 25 | 25 | 25 | 25 | 25 | 25 | 10 |
| Volume average particle diameter | 7.0 | 7.0 | 7.0 | 7.0 | 7.0 | 7.0 | 7.0 | 7.0 | 7.0 |
| (μm) | | | | | | | | | |
| Machine contamination | A | A | B | B | C | A | A | A | B |
| Fixing property | A | A | A | A | A | A | B | B | B |

TABLE 3

| | Exam- | Exam- | Exam- | Exam- | Exam- | Exam- | Exam- | Exam- | Exam- |
|---|---|---|---|---|---|---|---|---|---|
| | ple 10 | ple 11 | ple 12 | ple 13 | ple 14 | ple 15 | ple 16 | ple 17 | ple 18 |
| Toner | T9 | T10 | T11 | T12 | T13 | T14 | T15 | T16 | T17 |
| Polyester resin | A1 | A1 | A1 | A1 | A1 | A1 | A1 | A1 | A1 |
| Graft polymer including polyolefin | B1 | B1 | B1 | B1 | B1 | B1 | B1 | B1 | B1 |
| chain and vinyl resin chain | | | | | | | | | |
| Polyethylene wax | C1 | C1 | C1 | C1 | C1 | C1 | C1 | C1 | C1 |
| Supply rate (kg/h) | 15 | 15 | 15 | 15 | 15 | 15 | 15 | 15 | 15 |
| Preparation temperature (° C.) | 150 | 120 | 120 | 120 | 120 | 120 | 120 | 120 | 120 |
| Normal temperature and normal | 97 | 80 | 80 | 80 | 80 | 80 | 80 | 80 | 80 |
| humidity aggregation degree | | | | | | | | | |
| Small-diameter side number average | 1.37 | 1.30 | 1.20 | 1.70 | 1.80 | 1.41 | 1.41 | 1.41 | 1.41 |
| particle size distribution index | | | | | | | | | |
| (lower GSD) | | | | | | | | | |
| Surface exposure ratio | 30 | 25 | 25 | 25 | 25 | 11 | 30 | 38 | 25 |
| Volume average particle diameter | 7.0 | 7.0 | 7.0 | 7.0 | 7.0 | 7.0 | 7.0 | 7.0 | 5.0 |
| (μm) | | | | | | | | | |
| Machine contamination | C | B | C | B | C | B | B | C | B |
| Fixing property | A | A | A | A | A | A | A | A | A |

TABLE 4

| | Exam- | Exam- | Exam- | Exam- | Exam- | Comparative | Comparative | Comparative | Comparative |
|---|---|---|---|---|---|---|---|---|---|
| | ple 19 | ple 20 | ple 21 | ple 22 | ple 23 | Example 1 | Example 2 | Example 3 | Example 4 |
| Toner | T18 | T19 | T20 | T21 | T22 | CT1 | CT2 | CT3 | CT4 |
| Polyester resin | A1 | A1 | A1 | A1 | A1 | A1 | A1 | A7 | A1 |
| Graft polymer including polyolefin | B1 | B1 | B1 | B1 | B1 | B1 | B1 | B1 | — |
| chain and vinyl resin chain | | | | | | | | | |
| Polyethylene wax | C1 | C1 | C1 | C1 | C1 | C1 | C1 | C1 | C1 |
| Supply rate (kg/h) | 15 | 15 | 15 | 15 | 15 | 20 | 10 | 15 | 30 |
| Preparation temperature (° C.) | 120 | 120 | 120 | 120 | 120 | 90 | 180 | 120 | 70 |
| Normal temperature and normal | 80 | 80 | 80 | 80 | 80 | 100 | 65 | 80 | 80 |
| humidity aggregation degree | | | | | | | | | |
| Small-diameter side number average | 1.41 | 1.41 | 1.41 | 1.41 | 1.41 | 1.39 | 1.41 | 1.41 | 1.41 |
| particle size distribution index | | | | | | | | | |
| (lower GSD) | | | | | | | | | |
| Surface exposure ratio | 25 | 25 | 25 | 20 | 28 | 40 | 5 | 25 | 25 |
| Volume average particle diameter | 3.0 | 14.0 | 16.0 | 7.0 | 7.0 | 7.0 | 7.0 | 7.0 | 7.0 |
| (μm) | | | | | | | | | |
| Machine contamination | C | B | C | B | B | D | D | D | D |
| Fixing property | A | A | A | A | A | B | A | A | A |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An electrostatic charge image developing toner comprising:
toner mother particles that contain a polyester resin which is a polycondensate of a polycarboxylic acid compound and a polyol compound;
a graft polymer that includes a polyolefin chain and a vinyl resin chain;
a coloring agent; and
polyethylene wax,
wherein the polyol compound includes a polyol compound having a bisphenol structure in an amount of 0 mol % to 5 mol %. and an aliphatic polyol compound in an amount of 90 mol % to 100 mol %, and
wherein a normal temperature and normal humidity aggregation degree of the toner mother particles is from 70% to 97%.

2. The electrostatic charge image developing toner according to claim 1,
wherein the polyol compound having a bisphenol structure is bisphenol A.

3. The electrostatic charge image developing toner according to claim 1,
wherein the electrostatic charge image developing toner has a small-diameter side number average particle size distribution index of 1.30 to 1.70.

4. (canceled)

5. The electrostatic charge image developing toner according to claim 1,
wherein the polyol compound includes at least one of ethylene glycol and neopentyl glycol.

6. The electrostatic charge image developing toner according to claim 1,
wherein a surface exposure ratio of the polyethylene wax in the toner mother particles is from 10 atomic % to 35 atomic % based on the total sum of the atomic concentration of all elements measured by X-ray spectroscopy in the toner particles.

7. The electrostatic charge image developing toner according to claim 1,
wherein the electrostatic charge image developing toner has a volume average particle diameter of from 5.0 μm to 14.0 μm.

8. An electrostatic charge image developer comprising:
the electrostatic charge image developing toner according to claim 1; and a carrier.

9. A toner cartridge comprising:
a container that contains the electrostatic charge image developing toner according to claim 1,
wherein the toner cartridge is detachable from an image forming apparatus.
